(19) United States
(12) Patent Application Publication
(10) Pub. No.: US 2015/0014986 A1
(43) Pub. Date: Jan. 15, 2015

(54) MAGNETIC CONNECTION STRUCTURE

(71) Applicant: Xiamen Runner Industrial Corporation, Xiamen (CN)

(72) Inventors: Xi-Min Chen, Xiamen (CN); Ke-Sheng Peng, Xiamen (CN); Li-Zhong Liao, Xiamen (CN)

(21) Appl. No.: 14/329,117

(22) Filed: Jul. 11, 2014

(30) Foreign Application Priority Data
Jul. 11, 2013 (CN) 201320409364.6

(51) Int. Cl. E03C 1/04; F16L 37/00

(52) U.S. Cl. CPC E03C 1/0404; F16L 37/004; E03C 2001/0415; E03C 2001/0414
USPC 285/9.1

(57) ABSTRACT

A magnetic connection structure, includes a ring-shape magnetic sleeve body, made of mixed magnetic iron powder and plastic by means of ejection-to-mode; and a plastic fastener, provided in an arc-shape opening on both sides of the ring-shape magnetic sleeve body, for fastening a faucet seat or an ejection head. In the magnetic connection structure, the magnetic sleeve body and the plastic fastener are formed by means of ejection-to-mode separately. The magnetic sleeve body is formed by ejection-to-mode using magnetic iron powder and plastic mixed at a certain ratio; while the magnetic fastener is formed by means of ejection-to-mode separately. Then, the magnetic sleeve body and the plastic fastener are fastened together, to achieve said magnetic connection structure, that is low in production cost and easy to install. In case the plastic fastener is damaged, it can be replaced readily.

### BACKGROUND OF THE INVENTION

1. Field of Invention

The present invention relates to a magnetic connection structure, and in particular to a magnetic connection structure used for a pulling type faucet.

2. The Prior Arts

In general, a conventional faucet is provided with a faucet main body, one or a plurality of water flow control devices, and an ejection tube. The ejection tube is used for ejecting the water flowing through a valve. For this type of faucet, the water ejection is fixed to a single direction; or alternatively, the ejection tube can be rotated, yet it can only rotate within a certain range, so that water ejection is limited to that range.

To improve this structure, the conventional faucet is provided with a separate and distinct ejection head, that can be controlled manually, to provide user with more operation flexibility according to the actuation direction and actuation point of water ejection. In particular, in order to facilitate spraying water on the objects downward, the ejection head is provided with a pliable tube attached to it, to allow the ejection head to be pulled out from a fixed seat to move around based on the actual requirements.

However, for this type of faucet, an additional space has to be provided on the top end of its back side for installing the ejection head, and a separate hole has to be provided to allow passage through the top end of its back side. Therefore, this kind of structure is rather complicated.

In addition, China Patent Case No. 200820101783.2 “ Plastic Connection Structure” discloses a plastic connection structure. That plastic connection structure is actually a ring sleeve body, wherein it is provided with a multi-pole magnetic ring. The multi-pole magnetic ring is sleeved onto a washer, to form together with the washer in the outer shell of a plastic piece integrally into a plastic connection piece. Further, a fastener is formed on the outer shell of the plastic connection piece to match and work in cooperation with a faucet seat or an ejection head. For this type of plastic connection structure, the production steps are numerous and rather difficult, so that the production cost is high. Moreover, in case a connection piece of magnetic iron is used directly, it can not ensure matching and fastening with the faucet seat or the ejection head.

Therefore, presently, the design and performance of the faucet connection structure is not quite satisfactory, and it has much room for improvement.

### SUMMARY OF THE INVENTION

In view of the problems and drawbacks of the prior art, the present invention provides a magnetic connection structure for a faucet, to effectively overcome the shortcomings of the prior art.

A major objective of the present invention is to provide a magnetic connection structure, that is easy to produce at reduced cost, and is convenient to position and install.

To achieve the object of the present invention, the present invention provides a magnetic connection structure, including: a ring-shape magnetic sleeve body, and a plastic fastener. Wherein, the magnetic sleeve body is formed by the mixed magnetic iron powder and plastic and by means of ejection-to-mode. The plastic fastener is provided in an arc-shape opening on both sides of said ring-shape magnetic sleeve body, for fastening a faucet seat or an ejection head.

In addition, on both ends of the arc-shape opening are each provided with an extending protrusions extending inward, for fastening the plastic fastener, so that on both ends of the plastic fastener are each provided with a corresponding positioning flange.

Moreover, on the surrounding wall of the arc-shape opening is provided with a wedge-shape protrusion block, for inserting and connecting the plastic fastener. On the side wall of the plastic fastener is provided with an indent slot for connecting and fastening the wedge-shape protrusion block.

For the magnetic connection structure of the present invention, the magnetic sleeve body and the plastic fastener are produced by means of ejection-to-mode separately. The magnetic sleeve body is formed by ejection-to-mode using the magnetic iron powder and plastic mixed at a certain ratio; while the plastic fastener is produced by means of another ejection-to-mode separately. And then, the magnetic sleeve body and the plastic fastener are joined and fastened together, to form a magnetic connection structure, that is low in production cost and easy to install. In case the plastic fastener is damaged, it can be replaced readily.

Further scope of the applicability of the present invention will become apparent from the detailed descriptions given hereinafter. However, it should be understood that the detailed descriptions and specific examples, while indicating preferred embodiments of the present invention, are given by way of illustration only, since various changes and modifications within the spirit and scope of the present invention will become apparent to those skilled in the art from this detailed descriptions.

### BRIEF DESCRIPTION OF THE DRAWINGS

The related drawings in connection with the detailed descriptions of the present invention to be made later are described briefly as follows, in which:

FIG. 1 is an exploded/schematic diagram of a pulling type faucet according to the present invention;

FIG. 2 is a schematic diagram of a pulling type faucet of state 1 to be used as an ejection head according to the present invention;

FIG. 3 is a schematic diagram of a pulling type faucet of state 2 to be used for fixing a faucet according to the present invention;

FIG. 4 is a perspective/schematic diagram of a magnetic connection structure according to the present invention;

FIG. 5 is a cross section view of a magnetic connection structure according to the present invention; and

FIG. 6 is an exploded/schematic diagram of a magnetic connection structure according to the present invention.

### DETAILED DESCRIPTION OF THE PREFERRED EMBODIMENT

The purpose, construction, features, functions and advantages of the present invention can be appreciated and understood more thoroughly through the following detailed description with reference to the attached drawings.

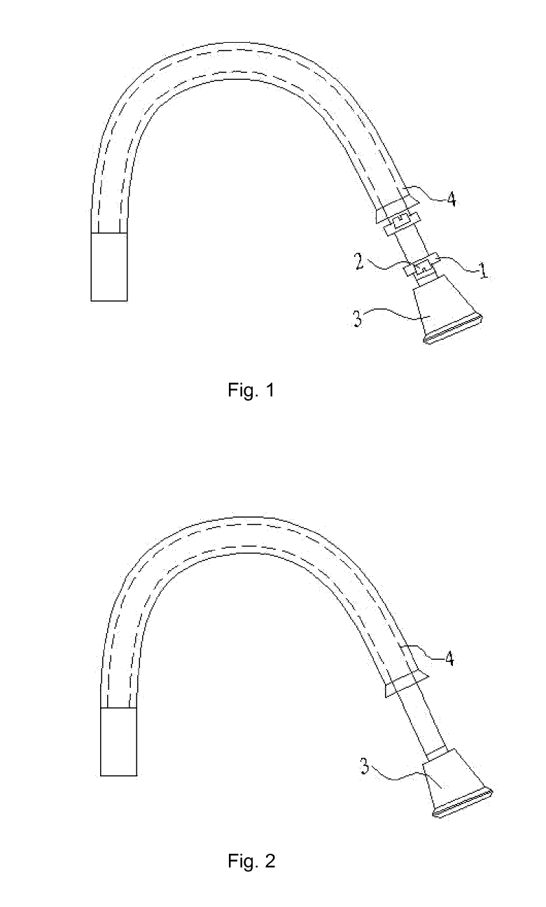

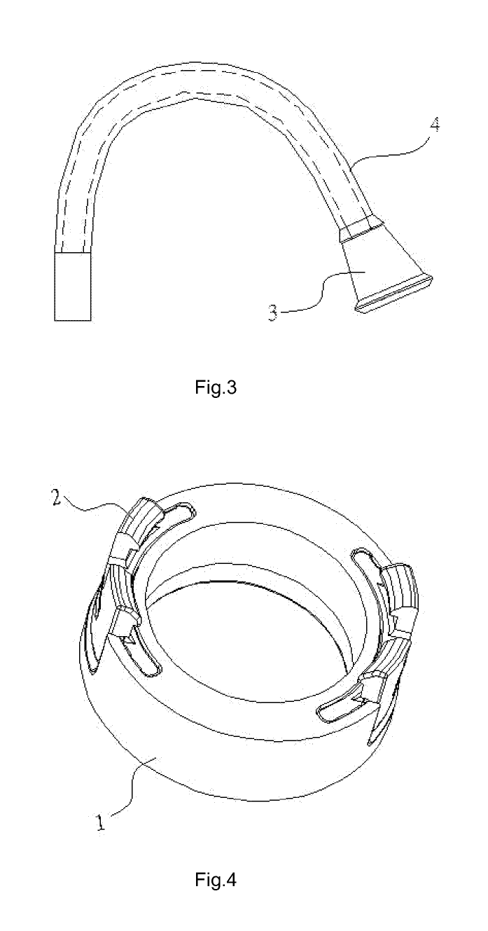

Refer to FIGS. 1, 2, 3 respectively for an exploded/schematic diagram of a pulling type faucet according to the present invention; a schematic diagram of a pulling type faucet of state 1 to be used as an ejection head according to the present invention; and a schematic diagram of a pulling type faucet of state 2 to be used for fixing a faucet according to the present invention.

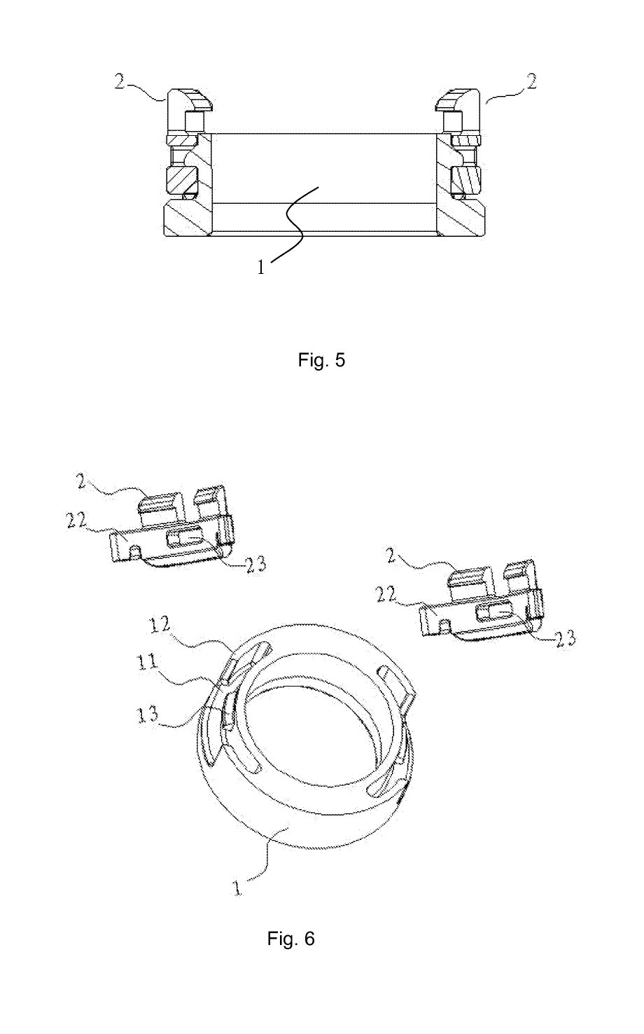

Also, refer to FIGS. 4, 5, 6 respectively for a perspective/schematic diagram of a magnetic connection structure according to the present invention; a cross section view of a magnetic connection structure according to the present invention; and an exploded/schematic diagram of a magnetic connection structure according to the present invention. As shown in FIGS. 4, 5, 6, the present invention provides a magnetic connection structure, including: a ring-shape magnetic sleeve body 1, and a plastic fastener 2. Wherein, the magnetic sleeve body 1 is made of mixed magnetic iron powder and plastic through ejection-to-mode. The plastic fastener 2 is provided in the arc-shape opening 11 on both sides of said ring-shape magnetic sleeve body 1, for fastening a faucet seat 3 or an ejection head 4.

To be more specific, on both ends of the arc-shape opening 11 are each provided with an extending protrusion 12 extending inward, used for fastening the plastic fastener 2, so that on both ends of the plastic fastener 2 are each provided with a corresponding positioning flange 22. Moreover, on the surrounding wall of the arc-shape opening 11 is provided with a wedge-shape protrusion block 13, for inserting into and connecting the plastic fastener 2. On the side wall of the plastic fastener 2 is provided with an indent slots 23 for fastening and connecting the wedge -shape protrusion block 13.

In applying the present invention, after installing the magnetic connection structure to the faucet seat 3 and the ejection head 4, the ejection head 4 is retracted into the faucet seat 3, thus the ejection head 4 is attached to the faucet seat 3 automatically through magnetic attraction.

The above detailed description of the preferred embodiment is intended to describe more clearly the characteristics and spirit of the present invention. However, the preferred embodiments disclosed above are not intended to be any restrictions to the scope of the present invention. Conversely, its purpose is to include the various changes and equivalent arrangements which are within the scope of the appended claims.

What is claimed is:

1. A magnetic connection structure, including:
a ring-shape magnetic sleeve body, made of mixed magnetic iron powder and plastic by means of ejection-to-mode; and
a plastic fastener, provided in an arc-shape opening on both sides of said ring-shape magnetic sleeve body, for fastening a faucet seat or an ejection head.

2. The magnetic connection structure as claimed in claim 1, wherein on both ends of said arc-shape opening are each provided with an extending protrusion extending inward, for fastening said plastic fastener, so that on both ends of said plastic fastener are each provided with a corresponding positioning flange.

3. The magnetic connection structure as claimed in claim 1, wherein a wedge-shape protrusion block is provided on surrounding walls of said arc-shape opening, for inserting and connecting said plastic fastener, and an indent slot is provided on a side wall of said plastic fastener, for connecting and fastening said wedge-shape protrusion block.
